(19) United States
(12) Patent Application Publication
(10) Pub. No.: US 2024/0314586 A1
(43) Pub. Date: Sep. 19, 2024

(54) METHOD AND APPARATUS FOR MANAGING DEVICE TO DEVICE COMMUNICATIONS IN A WIRELESS NETWORK

(71) Applicant: SEMTECH CORPORATION, Camarillo, CA (US)

(72) Inventors: Gustav Gerald VOS, Tsawwassen (CA); Recep Serkan DOST, Coquitlam (CA); Steven John BENNETT, Coquitlam (CA); Nikhil KARANDE, Coquitlam (CA)

(21) Appl. No.: 18/575,282

(22) PCT Filed: Jul. 5, 2022
(86) PCT No.: PCT/CA2022/051059

§ 371 Date: Dec. 28, 2023

Related U.S. Application Data
(60) Provisional application No. 63/218,658, filed on Jul. 6, 2021.
(60) Provisional application No. 63/235,573, filed on Aug. 20, 2021.

(51) Int. Cl. H04W 24/02; H04W 16/18; H04W 24/10

(52) U.S. Cl. CPC H04W 24/02; H04W 16/18; H04W 24/10

(57) ABSTRACT

There is provided a method and apparatus for managing device-to-device communications in a wireless network, for example a self-organizing network. The method includes collecting, by a wireless network controller, information regarding one or more key performance indicators (KPIs). The information relates to one or more of a 5 ranking of the one or more KPIs and a target value of the one or more KPIs. The method further includes determining, by the wireless network controller, an optimal configuration of the wireless network that best meets the collected information relating to the one or more KPIs. The method additionally includes assigning, by the wireless network controller, a role to each of one or more network devices associated with the 10 wireless network based on the optimal configuration of the wireless network. The role is selected from a gateway (GW), a mesh node, a cellular node and an end node (EN).

### CROSS-REFERENCE TO RELATED APPLICATIONS

This application claims the benefit of priority to U.S. Provisional Patent Application Ser. No. 63/218,658 entitled “Method and Apparatus for Managing Device to Device Communications in a Wireless Network” filed Jul. 6, 2021 and U.S. Provisional Patent Application Ser. No. 63/235,573 entitled “Method and Apparatus for Managing Device to Device Communication” filed Aug. 20, 2021, the contents of which are hereby incorporated by reference in their entirety.

### FIELD

The present invention pertains in general to wireless communication and in particular to methods and apparatuses for managing device-to-device communications in a wireless network.

### BACKGROUND

A self-organizing network (SON) is a network automation technology that is designed to perform automatic configuration, optimization, diagnosis and healing of wireless networks. A SON generally includes a controller (i.e. SON controller) that is at least responsible for assigning a device's role as one of a gateway (GW), a cellular device (CD) and an end node (EN) within a wireless network. The GW is responsible for collecting data from a number of end nodes via a device-to-device (D2D) protocol 20) and sending the collected data to the application server, for example via a cellular protocol. The GW may also be responsible for receiving data from the application server, for example via a cellular protocol, and transmitting the received data to the end nodes via a D2D protocol. In addition, application data is transmitted and received directly to a CD via a cellular protocol. The application data generated by the client is transmitted from an EN to a GW via a D2D protocol. The SON controller is also responsible for assignment of ENs to GWs, for example by informing or instructing the ENs to connect to a particular GW.

To make a SON more effective, a homogenous set of devices needs to be deployable without high cost or power consumption. In other words, all devices should be able to function as a GW, EN or CD at a marketable low cost with low power consumption.

Generally, the configuration of a SON depends on one or more requirements which can include application requirements (e.g. reliability, data rate, latency, etc.) and customer requirements (e.g. power consumption, cost of service, etc.). However, current SONs do not provide a method or procedure allowing the SON controller to adjust procedures in view of these various requirements. As such, the D2D communication in a SON may not be suitable at least in certain conditions.

Therefore there is a need for a method and apparatus for managing device-to-device communications in a wireless network, that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of embodiments of the present invention is to provide a method and apparatus for managing device-to-device communications in a wireless network. In accordance with embodiments, there is provided a method for managing communications in a wireless network. The method includes collecting, by a wireless network controller, information regarding one or more key performance indicators (KPIs). The information relates to one or more of a ranking of the one or more KPIs and a target value of the one or more KPIs. The method further includes determining, by the wireless network controller, an optimal configuration of the wireless network that best meets the collected information relating to the one or more KPIs. The method additionally includes assigning, by the wireless network controller, a role to each of one or more network devices associated with the wireless network based on the optimal configuration of the wireless network. The role is selected from a gateway (GW), a mesh node, a cellular node and an end node (EN).

In some embodiments, the method includes assigning, by the wireless network controller, a role to one or more of the one or more network devices associated with the wireless network based on the optimal configuration of the wireless network.

In accordance with embodiments, there is provided a wireless network controller within a wireless network. The wireless network controller includes a network interface for receiving data from and transmitting data to network devices connected to the wireless network, a processor and machine readable memory storing machine executable instructions. The machine executable instructions, when executed by the processor configure the wireless network controller to collect information regarding one or more key performance indicators (KPIs). The information relates to one or more of a ranking of the one or more KPIs and a target value of the one or more KPIs. The machine executable instructions, when executed by the processor further configure the wireless network controller to determine an optimal configuration of the wireless network that best meets the collected information relating to the one or more KPIs and assign a role to each of one or more network devices associated with the wireless network based on the optimal configuration of the wireless network. The role is selected from a gateway (GW), an end node (EN), a mesh node and a cellular node and an end node (EN).

In accordance with embodiments, there is provided a method for managing communications in a wireless network. The method includes collecting, by a wireless network controller, one or more key performance indicators (KPI), each KPI indicative of an attribute of the wireless network and predicting, by the wireless network controller, performance of the wireless network based on the collected one or more KPIs. Upon determination that the predicted performance meets a target performance, the method further includes organizing, by the wireless network controller, the wireless network based on the predicted performance of the wireless network, the organization including assigning the role of one or more network devices as a gateway (GW) or an end node (EN).

In some embodiments, the wireless network is a self-organizing network (SON) and the wireless network controller is a SON controller.

In some embodiments, the one or more KPIs include one or more of: a target monthly operating cost, a device originated (DO) latency, a device terminated (DT) latency, a data volume, a data rate, a reliability, and a power consumption of at least one of the GWs and the ENs. In some embodiments, one or more of the KPIs have assigned values. In some embodiments, the wireless network controller estimates values of the remaining KPIs.

In some embodiments, the wireless network controller organizes the wireless network based further on one or more relational factors, the relational factors including relationships between two of: an operation cost, a number of end nodes (EN) per gateway (GW), an EN originated latency, an EN terminated latency, a length of GW discontinuous reception (DRX) cycle, a length of EN DRX cycle, a maximum number of 5 mesh hops, a bandwidth data rate, a reliability, a number of GWs within a coverage area of the ENs, a power consumption of the GW, a coverage level, and an aggregation level. In some embodiments, the wireless network controller further reorganizes the wireless network after deployment, based on one or more operational factors, the operational factors including a radio frequency (RF) topology information, a data load on each EN and GW, remaining battery capacity and a network geographical topology.

In some embodiments, the method further includes initiating, by the wireless network controller, a link quality evaluation (LQE) process to update RF link quality information. In some embodiments, the LQE process includes transmitting, by the wireless network controller, a LQE configuration message to one or more network devices and synchronizing the network devices. The LQE process further includes transmitting, by one of the network devices, an LQE synchronization signal (LQE_SS), measuring and recording, by remaining devices of the network devices, quality of the LQE_SS and transmitting, by each network device, an LQE report to the wireless network controller, the LQE report based on the measurement of the quality of the LQE_SS. In some embodiments, the one or more network devices are deployed out of cellular coverage (OOCC) area, and synchronizing includes broadcasting, by one or more ENs and/or GWs, a device-to-device (D2D) synchronization signal according to an instruction of the wireless network controller. In some embodiments, the wireless network controller selects the one or more ENs and/or GWs to broadcast the D2D synchronization signal.

In some embodiments, the wireless network controller provides one or more ENs and GWs instructions in respect to how frequently transmit the D2D synchronization signal. In some embodiments, the wireless network controller determines a level of the D2D synchronization based on mobility level indicated by the ENs and desired reliability level.

In accordance with embodiments, there is provided a wireless network controller within a wireless network. The wireless network controller includes a network interface for receiving data from and transmitting data to network devices connected to the wireless network, a processor and machine readable memory storing machine executable instructions. The machine executable instructions, which when executed by the processor configure the wireless network controller to collect one or more key performance indicators (KPI), each KPI indicative of an attribute of the wireless network and predict performance of the wireless network based on the collected one or more KPIs. Upon determination that the predicted performance meets a target performance, the machine executable instructions, which when executed by the processor further configure the wireless network controller to organize the wireless network based on the predicted performance of the wireless network, the organization including assigning one or more network devices as a gateway (GW) or an end node (EN).

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an example of a wireless network including gateways, end nodes and radio frequency links connecting gateways and end nodes.

FIG. 2 illustrates a link quality evaluation (LQE) process performed at network devices, in accordance with embodiments of the present disclosure.

FIG. 3 illustrates a method for managing device-to-device communications in a wireless network, in accordance with embodiments.

FIG. 4 illustrates a method for managing device-to-device communications in a wireless network, in accordance with embodiments.

FIG. 5 is a schematic diagram of an electronic device, according to embodiments.

It will be noted that throughout the appended drawings, like features are identified by like reference numerals.

### DETAILED DESCRIPTION

### Definitions

In the present disclosure, it is to be understood that the terms ‘organizing’ and ‘configuring’ can be interchangeably used and generally have the same meaning. It is also to be understood that the variant forms of ‘organizing’ and ‘configuring’ (e.g. organization, configuration) can be interchangeably used and generally have the same meaning.

The present disclosure provides a method and apparatus for managing device-to-device communications in a wireless network (e.g. self-organizing network (SON)). For example, managing a wireless network (e.g. SON) can be considered to align with the optimization of the operational characteristics of the wireless network based on one or more criteria or requirements. As presented above, the configuration of a wireless network depends on various requirements, including application requirements (e.g. reliability, data rate, latency, etc.) and customer requirements (e.g. power consumption, cost of service, etc.). As such, it is difficult to have one fixed method or procedure for a wireless network controller as the wireless network is organized or configured based on various application requirements and customer requirements. Therefore, it is desired to have a method and apparatus allowing the wireless network controller to adjust its procedures in view of these various requirements and thus manage device to device communication in a wireless network.

According to embodiments of the present disclosure, the wireless network controller (e.g. SON controller) predicts or estimates the performance of the wireless network (e.g. SON) based on at least some of the key performance indicators (KPI) that the customer requires, and provides the predicted performance to customers. The wireless network controller may determine if the predicted performance is acceptable to the customer based on the response received from the customer, or upon the comparison of the predicted performance with a target performance that has been provided by the customer. If the response indicates the estimated performance is acceptable, (for example it is determined that the predicted performance meets the target performance) the wireless network controller proceeds to configure or re-configure the network in order to meet that accepted performance. Various KPIs may be collected by devices (e.g. GW, EN, etc.) in the wireless network and may include one or more of: target monthly operating cost, device originated (DO) latency, device terminated (DT) latency, data volume, data rate, reliability, and power consumption of the gateway (GW) or the end node (EN).

One way of optimizing a wireless network could be that the customer sets or assigns an absolute target value for each KPI and the wireless network controller adjusts its procedure(s) in order to meet the target KPIs. However, in most cases, the wireless network controller would not be able to fulfill the entire target KPIs. For instance, when the customer wishes to set low target monthly operating cost and high reliability, these KPIs cannot be met simultaneously as high reliability requires more GWs, which increase operating costs.

In some embodiments, each KPI associated with a wireless network (e.g. SON) can be numerically ranked by a customers, thereby indicating the significance or weight of each KPI. For example, given the range of 0 to 9, a customer may set the most important KPI to optimize to ‘9’, and the least important (or not important) KPI to ‘0’. In this manner, during the optimizing of the wireless network, the wireless network controller is provided with guidance for achieving the desired KPIs associated with the wireless network.

According to embodiments, the wireless network controller (e.g. SON controller) predicts or estimates performance, for example based on the one or more KPIs with associated weighting for use during optimization of the performance of the wireless network (e.g. SON). The wireless network controller can render the estimated performance using each KPI and the particular KPI's associated units. For example, appropriate units can be based on dollars ($), milliseconds (msec) and bits per second (bps). The above outlined KPIs can be defined with units as follows: target monthly operating cost based in $, device originated (DO) latency based in msec, device terminated (DT) latency based in msec, data rate based in bps, reliability based on ENs per GW and/or based on GW's available to each EN, and power consumption based in mW for an EN and a GW. In some embodiments, the wireless network controller provides the estimated KPIs (e.g KPIs outlined above) as a range of predicted performance.

According to embodiments, the wireless network controller (e.g. SON controller) may predict only some of the KPIs (i.e. not all of the KPIs) depending on how the KPI target values are set by the customer. In some embodiments, if the customer sets target values for a subset of available KPIs, the wireless network controller may only predict values of the remaining KPIs only. In some embodiments, if the customer sets the target value or target range of some KPIs, the wireless network controller can automatically predict or adjust the values or ranges of the KPIs that are associated with (e.g. affected by) those KPIs for which the target value or range is set by the customer. For example, if the customer sets a low target value for the monthly operation cost, the wireless network controller can automatically update the KPI values affected by the monthly operation cost.

In some embodiments, the wireless network controller (e.g. SON controller) predicts or adjusts the values or ranges of one or more KPIs for each geographical area. As the customer sets target KPI values differently in each geographical area, the wireless network controller may need to independently estimate the values or ranges of KPIs for each geographical area. This process of KPI estimation or determination can allow a wireless network controller to build configure the network (e.g. SON) differently or independently for each geographical area.

In some embodiments, the wireless network controller (e.g. SON controller) predicts or adjusts the values or ranges of KPIs for each application. It should be noted that the customer can deploy more than one application (e.g. security cameras and sensors). As the customer sets target KPI values differently for each application, the wireless network controller may need to independently estimate the values or ranges of KPIs for each application. A wireless network controller can therefore build or configure the network (e.g. SON) differently or separately when servicing different applications. For example, there can be a maximum of 4 security camera ENs (e.g. security camera applications) connected to one GW, whereas there may be 30 sensory ENs (e.g. sensor applications) connected to one GW.

According to embodiments, the network can be organized or configured (e.g. self-organized, self-configured) in accordance with one or more relational factors, as illustrated below.

A first relational factor to consider when organizing the network is the relationship between the operation cost and the number of ENs per GW. The operating cost can be inversely proportional to the number of end nodes per gateway (i.e. “operating cost∝1/(ENs per GW)”). In other words, as more end nodes are supported per GW, the lower the number of total GWs that will be required to cover the desired location and therefore the total operating cost may decrease.

Another relational factor to consider when organizing the network is the relationship between EN originated latency and each of the gateway DRXs and maximum number of mesh hops. The latency for EN originated connections (i.e. EN originated latency) can be directly proportional to the length of the discontinuous reception (DRX) cycle of the gateway (i.e. “EN originated latency∝gateway DRX”). Put another way if the GW is in a longer DRX cycle, it will take longer for the EN to connect with the GW and therefore the latency would increase. The latency for EN 10) originated connections can be directly proportional to the maximum number of mesh hops (i.e. “EN originated latency∝maximum number of mesh hops”).

Another relational factor to consider when organizing the network is the relationship between EN terminated latency and each of the gateway DRX, EN DRX and maximum number of mesh hops. The latency of EN terminated connections can be directly proportional to the length of the gateway DRX cycle and the length of the end node DRX cycle (i.e. “EN terminated latency∝gateway DRX”; “EN terminated latency∝EN DRX”), similar to the case of EN originated latency. The latency for EN connections can be directly proportional to the maximum number of mesh hops (i.e. “EN terminated latency∝maximum number of mesh hops”).

Another relational factor to consider when organizing the network is the relationship between the bandwidth data rate and the number of ENs per GW. The maximum data rate supported can be inversely proportional to the number of end nodes supported by one gateway (i.e. “bandwidth data rate∝1/(number of ENs/GW)”), as the bandwidth needs to be shared between all of the supported end nodes.

Another relational factor to consider when organizing the network is the relationship between reliability and number of gateways in the coverage of the end nodes. Reliability is dependent upon the total number of GWs to which the end nodes can connect. For example, when an end node cannot connect with its primary GW within a coverage area, the end node can try to connect with another GW in the same coverage area thereby successfully establishing a reliable connection. Put another way, the greater the number of GWs in the coverage are of the end node, the higher the reliability of the connection that will be established (i.e. “reliability x number of gateways within the coverage area of end nodes”). Therefore, in various embodiments, the wireless network controller (e.g. SON controller) may assign one or more back-up GW to an EN so that the EN can be connected to the network through one of the back-up GWs even if the EN's primary GW does not operate properly. A person of ordinary skill in the art can readily understand that the EN's connection failure can be caused by various reasons, such as poor connection quality, network congestion or GW failure.

Another relational factor to consider when organizing the network is the relationship between the power consumption of the GW and each of the ENs per GW, coverage, and aggregation level (i.e. “power consumption of GW∝the number of ENs per GW, coverage level, aggregation level”). The power consumption of the GW is dependent upon the number of ENs it has to serve. The power consumption of the GW is also dependent upon its cellular coverage level. Generally, good coverage requires less power. Further, the power consumption of the GW is also dependent upon the level of aggregation (e.g. how much buffering and how long the buffering can occur within the GW). Generally, more aggregation requires less power. The power consumption may be dependent upon other subsidiary factors, for example factors that are less under the control of the wireless network controller (e.g. SON controller). Such factors may include one or more of the number of transactions per day and the size of each transaction.

According to embodiments, the wireless network controller (e.g. SON controller) can further optimize the network after initial configuration of the wireless network (e.g. SON). The wireless network controller may further organize the wireless network, after commencement of operation, and this further reorganization can be based on one or more operational factors such as radio frequency (RF) topology information, data load on each EN and GW, remaining battery capacity and network geographical topology.

In various embodiments, the wireless network controller (e.g. SON controller) can obtain RF topology information. For example, the SON controller may receive one or more reports, from one or more ENs and GWs, about the cellular link quality (e.g. received signal strength indicator (RSSI)/reference signal received quality (RSRQ)) and device to device (D2D) link quality. The wireless network controller (e.g. SON controller) may control how often it receives these reports, as transmission of the reports can increase data costs and consume batteries of network devices (e.g. EN, GW). For example, the SON controller may determine to receive the cellular link quality reports periodically or on an on-demand basis. In this instance, the SON controller may instruct each of ENs and GWs that are transmitting the reports.

Generally speaking, GWs with better coverage attach and serve more nodes. As such, if the GW reports high values of measured metrics (e.g. RSSI/RSRQ) which indicates that GW provides better coverage, the network may be optimized such that the GW can attach more nodes and serve the attached nodes, or can be operatively associated with more nodes.

According to some embodiments, the wireless network controller (e.g. SON controller) can autonomously determine data load on each EN and GW in the wireless network (e.g. SON). In some other embodiments, the wireless network controller may obtain the data load information from user plane entities (e.g. packet data network gateway (PGW)). The wireless network controller and user plane entities may communicate through an application programming interface (API), such as Cloud2Cloud API.

It should be noted that the data load (e.g. data load per month) is not necessarily directly proportional to the number of nodes (e.g. EN, GW) in the network. In other words, at least in some cases, a GW has many ENs operatively/communicatively attached thereto, but does not generate a significant amount of data. In such cases, the data load on the GW may not be high, even if the GW serves or supports a high number of ENs. In various embodiments, based on the data load information related to the GWs (e.g. data load on a certain GW), the wireless network controller (e.g. SON controller) can determine which GWs have capacity to take more data load and which GWs need to reduce the amount of data load.

According to embodiments, the wireless network controller (e.g. SON controller) may optimize the network based on remaining battery capacity. In various embodiments, GWs and ENs may report their remaining battery capacity to the wireless network controller. When the wireless network controller identifies a certain GW's battery level is low (e.g. when the GW's battery level is below a threshold or is lower than other nearby GWs or ENs), the wireless network controller can promote another EN to operate as a GW (e.g. as a replacement of the GW with low remaining battery capacity). In other words, the wireless network controller reassigns the EN as a new gateway, and can also reassign the GW with low remaining battery capacity as an EN.

According to embodiments, the wireless network controller (e.g. SON controller) optimizes the network based on geographical network topology. The geographical network topology information can aid the wireless network controller in order to determine potential connectivity between GWs and ENs. Put another way, the wireless network controller can determine which ENs can connect to which GWs, using the geographical network topology information (e.g. how far each of ENs and GWs are geographically located). Such information can help the wireless network controller select ENs and GWs that should execute a link quality evaluation (LQE) process. In addition, the geographical location information can aid the wireless network controller with determining the potential cellular coverage of ENs and GWs and therefore the wireless network controller can more effectively select ENs that would function well as GWs. For example, if the location of each GW is reported as a metric, for example a cell identifier (Id), global navigation satellite system (GNSS), positioning over Long-Term Evolution (PoLTE) or similar metrics, the wireless network controller can use the reported metrics when selecting the best ENs that can be assigned as GWs.

### Radio Frequency Topology Mapping

As part of organizing or configuring the wireless network (e.g. SON), for example assigning a role to the network device role as a GW or an EN, the wireless network controller (e.g. SON controller) can access details related to the RF topology information (i.e. information indicative of the RF topology of the RF links). In normal operations, the wireless network controller can obtain updated link quality information for EN-to-GW links using on-going transmissions. However, the wireless network controller may not be able to obtain accurate link quality information or the most updated link quality information for other types of links (e.g. EN-to-EN and GW-to-GW RF links) because there is typically no transmission occurring between two ENs or between two GWs.

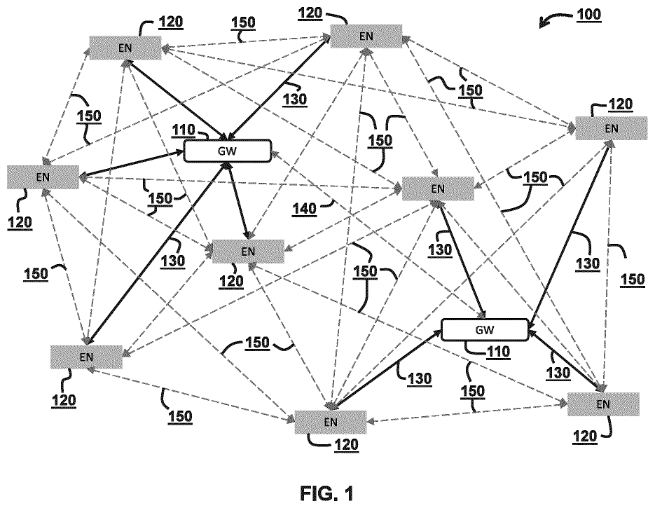

FIG. 1 illustrates an example of a wireless network (e.g. self-organizing network (SON)) 100 including gateways (GW), end nodes (EN) and radio frequency links connecting GWs and ENs. Referring to FIG. 1, the wireless network 100 includes two GWs 110 and several ENs 120. Each of the ENs 120 can be communicatively connected and therefore can be operatively connected to each of the GWs 110. As illustrated in FIG. 1, each EN 120 may be communicatively connected and therefore operatively connected to one of the GWs 110 (e.g. nearby GW) but not (always) communicatively or operatively connected to the other GWs 110, for example due to coverage constraints. The solid lines between the GW 110 and the EN 120 represent EN-to-GW RF links 130, and the dashed lines between the two GWs 110 and the dashed lines between the two ENs 120 represent the GW-to-GW RF links 140 and the EN-to-EN RF links 150, respectively. The EN-to-GW RF links 130 can be evaluated by the GW 110 or the wireless network controller (e.g. SON controller). However, the GW-to-GW RF links 140 and the EN-to-EN RF links 150 cannot be accurately evaluated by the GW 110 or the wireless network controller (e.g. SON controller). Each of the ENs 120 can be operatively connected to each other, and each of the GWs 110 can be operatively connected to each other. In some cases, some of the ENs 120 are not always communicatively or operatively connected to each other (e.g. connection between two ENs is not successfully established), for example due to coverage constraints. In some cases, some of the GWs 110 are not always communicatively or operatively connected to each other (e.g. connection between two GWs is not successfully established), for example due to coverage constraints.

The EN-to-GW RF links 130 (i.e. as illustrated in solid lines in FIG. 1) are used for regular transmissions, and therefore the wireless network controller (e.g. SON controller) can obtain information on the RF link quality. On the other hand, the wireless network controller would not be able to obtain any link quality information of the GW-to-GW RF links 140 and the EN-to-EN RF links 150 (i.e. illustrated as dashed lines in FIG. 1). In order to overcome this issue, the wireless network 100 can perform and/or initiate link quality measurements on the GW-to-GW RF links 140 and the EN-to-EN RF links 150. After the measurements, each device in the wireless network 100 reports the results to the wireless network controller.

According to embodiments, the wireless network controller (e.g. SON controller) may perform a link quality evaluation (LQE) process in order to obtain accurate and updated RF link quality information for all types of RF links (e.g. EN-to-GW, EN-to-EN, GW-to-GW). In various embodiments, the LQE process includes transmitting a synchronization signal (e.g. LQE_SS) and performing RF link quality measurement. For example, in order for this evaluation to be performed, some of the network devices in the wireless network (e.g. SON) can send out LQE_SS while other devices perform RF link quality measurements.

In some embodiments, the LQE process can be performed and coordinated across the wireless network (i.e. system wide or group wide) in order to ensure that the device broadcasting the synchronization signal (e.g. LQE_SS) and the devices measuring the signal are synchronized. The measurement results can be transmitted from each device to the wireless network controller (e.g. SON controller) in order to establish the overall RF link quality topology of the wireless network.

According to embodiments, the wireless network controller (e.g. SON controller) can request the LQE be performed by a small group of devices or performed by all devices across the entire wireless network (e.g. SON) at once. The wireless network controller may require the LQE be performed by a small group of devices at one time as this process would reduce the network service disruption and reduce the power consumption by devices during the measurement process. As such, the wireless network controller may group the devices to perform the LQE. In some embodiments, different groups of devices may be assigned such that a group can be selected for performance of LQE at different times.

When selecting devices to be included in the group, the wireless network controller (e.g. SON controller) can select devices such that all devices in the group can be synchronized. One method to ensure synchronization of the devices in the group is for the wireless network controller (e.g. SON controller) to select devices which can decode or connect to the same cellular base-station (e.g. eNB, gNB, etc.) so that the base-station can be used as a common sync source. Another way to ensure all devices in the same group are synchronized is by using a synchronization source, for example GNSS.

In some embodiments, the wireless network controller (e.g. SON controller) may further select devices based on other factors that would aid with the wireless network controller's GW selection process. For instance, the wireless network controller may select devices based on geographical location (e.g. using GNSS, PoLTE, etc.) so that the wireless network controller can select devices positioned near each other.

According to embodiments, the wireless network controller (e.g. SON controller) initiates the LQE process by sending a LQE configuration message to devices that are participating in the LQE process. The LQE configuration message may include one or more of: a LQE group identifier (ID), a synchronization configuration information, a LQE process start time and duration, a LQE frequency (e.g. every 30 days), a device-specific LQE synchronization signal (LQE_SS) configuration information, a LQE_SS common search space and a LQE_SS quality reporting threshold.

The LQE group ID may indicate the group to which each device belongs. In some embodiments, a device may be configured such that it belongs to more than one LQE group.

The synchronization configuration information may include one or more of the following information—type of synchronization to use (e.g., GNSS, cellular BTS), course UTC date and time, and cellular ID of the base station used for the synchronization. The course UTC date and time may be used to schedule the LQE process in advance, for example greater than 3 hours. The course UTC date and time may be also used to schedule the LQE process periodically (e.g. every 10 days). The devices may be able to obtain the accurate UTC date and time from a base station in the LTE system information block (SIB) 19, GNSS (if equipped), or GW, for example.

In some embodiments, the LQE process start time and duration may be obtained through hyper system frame number (HSFN) or system frame number (SFN).

The device-specific LQE_SS configuration information may include transmission (Tx) time and LQE_SS configuration information. The Tx time represents the device specific time to transmit the LQE_SS that can be used by other devices to evaluate link quality (e.g. HSFN/SFN/subframe time). The LQE_SS configuration information may include the code used to generate the synchronization signal (i.e. LQE_SS).

The LQE_SS common search space represents a set of possible LQE_SS that the devices can attempt to detect.

The LQE_SS quality reporting threshold represents the minimum link quality required for the devices to report a detected LQE_SS.

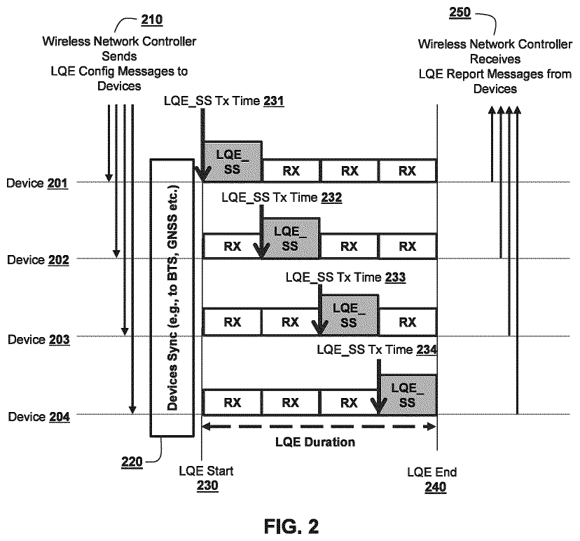

FIG. 2 illustrates a link quality evaluation (LQE) process performed at network devices, in accordance with embodiments of the present disclosure. As illustrated in FIG. 2, each of the devices 201, 202, 203 and 204 can perform the LQE process as follows. The devices 201, 202, 203 and 204 are selected by the wireless network controller (e.g. SON controller) such that all of these devices 201, 202, 203 and 204 can be synchronized.

At step 210, the wireless network controller (e.g. SON controller) initiates the LQE process by transmitting the LQE configuration message to the devices 201, 202, 203 and 204. The devices 201, 202, 203 and 204 wait until the LQE process starting time 230. The waiting time can be configured to provide sufficient time to perform device synchronization at step 220.

At step 220, the devices 201, 202, 203 and 204 are synchronized, for example, using GNSS or cellular base-station (e.g. eNB, gNB, etc.) ID, etc. For example, the devices 201, 202, 203 and 204 can decode the same cellular base-station so that the base-station can be used as a common synchronization source.

Then the LQE process starts at step 230. Each device measures and records the quality of the detected LQE_SS. During the LQE synchronization signal transmission time (e.g. LQE_SS Tx Time 231, 232, 233, 234), the device pause the measurement and transmit the LQE_SS. When the LQE synchronization signal transmission is finished, the device resumes the measurement and recordation of the quality of the detected LQE_SS until the LQE end time 240.

The LQE process is further illustrated with respect to each of the devices 201, 202, 203 and 204, respectively. At LQE_SS Tx Time 231, the device 201 transmits the LQE_SS and the remaining devices 202, 203 and 204 perform the RF link quality measurement. At LQE_SS Tx Time 232, the device 202 pauses the RF link quality measurement and starts transmitting the LQE_SS. The device 201 starts to perform the RF link quality measurement, and the remaining devices 203 and 204 continue to perform the RF link quality measurement. At LQE_SS Tx Time 233, the device 203 pauses the RF link quality measurement and starts transmitting the LQE_SS. The device 202 resumes the RF link quality measurement, and the remaining devices 201 and 204 continue to perform the RF link quality measurement. At LQE_SS Tx Time 234, the device 204 pauses the RF link quality measurement and starts transmitting the LQE_SS. The device 203 resumes the RF link quality measurement, and the remaining devices 201 and 202 continue to perform the RF link quality measurement. The LQE process ends at the LQE end time 240. At the LQE end time 240, the device 204 stops transmitting the LQE_SS, and the remaining devices 201, 202 and 203 stop the RF link quality measurement.

When the LQE process is finished, at step 250, each of the devices 201, 202, 203 and 204 reports their respective evaluation results (e.g. measurements) to the wireless network controller. In various embodiments, each of the devices 201, 202, 203 and 204 transmits the LQE report message to the wireless network controller. The LQE report may include one or more of: LQE_SS configuration detected (e.g. information indicative of which code was detected), LQE_SS timing (e.g. HSFN/SFN/subframe when the signal detected), and Quality of LQE_SS detected (e.g. RSRQ, RSSI)

According to embodiments, the LQE_SS can be one or a variety of signals, provided that the selected signal is known to the receiving devices. For example, the LQE_SS can be one or more of: primary synchronization signal (PSS), secondary synchronization signal (SSS), sounding reference signal (SRS), uplink (UL) sounding signal, and downlink control information (DCI) containing radio network temporary identifier (RNTI).

According to embodiments, in order to reduce the LQE duration, the wireless network controller (e.g. SON controller) can organize devices such that the LQE_SS are sent as close together as possible. The time between each LQE_SS transmission can be dependent upon the processing time for the LQE_SS detection. Although FIG. 2 shows that the LQE_SS signals are transmitted by the devices sequentially, it is merely an example, and the sequence of which device transmits the LQE_SS signal can be determined by the wireless network controller or in another way as would be readily understood by a person skilled in art. Further, while FIG. 2 shows that the LQE End 240 occurs after the end of LQE_SS Tx time 234 (i.e. LQE_SS transmission time of the device 204), it is also merely an example, and the LQE End 240, in some cases, can occur at the end of LQE_SS transmission time of the last device (e.g. LQE_SS Tx Time 234).

### High Power to Serve Out of Coverage Devices

When a device is deployed out of a cellular coverage (OOCC) area, and if the GW does not send a D2D synchronization signal or there are no GWs in the coverage area, the device that is in the OOCC area (i.e. OOCC device) would not be able to notify the wireless network controller about the current situation (e.g. notify the SON controller that it is out of coverage area). This problem can be avoided if GWs broadcast a continuous D2D synchronization signal including when there may or may not be another OOCC device in range. However, this (i.e. broadcasting the D2D synchronization signal all the time) would make the GW consume too much power. Moreover, it may be rare that a device is deployed in an OOCC area, and it will be significant waste of power and energy to make GWs broadcast the D2D synchronization signal all the time for type of rare situation. Therefore, it is desired to have a more effective way to serve and reach OOCC devices without significantly increasing battery consumption of the GW.

The probability that the above situation occurs can be lowered if the OOCC device uses advanced cellular synchronization algorithms (e.g. coverage enhancement (CE) mode B algorithms) which extend the coverage of cellular synchronization signals. For example, using advanced cellular synchronization algorithms, the OOCC device can decode the cellular synchronization channels/signals (e.g. PSS/SSS, PBCH) even when the OOCC device is out of the regular cellular coverage area and not able to communicate bi-directionally with the cellular base station.

According to embodiments, the wireless network controller (e.g. SON controller) may reduce the high power consumption of the GWs caused by continually broadcasting the D2D synchronization signal. The wireless network controller may direct or instruct the ENs (i.e., instead of GWs) in the wireless network (e.g. SON) to continually (or periodically etc.) transmit the D2D synchronization signal. The wireless network controller may instruct more than one ENs to send D2D synchronization signals thereby sharing the burden of transmitting D2D synchronization signals with a group of ENs in the network. The burden of transmission can be shared using one or more suitable methods, for example through the use of a round robin algorithm.

According to embodiments, when the wireless network controller (e.g. SON controller) is notified of a potential OOCC device, the wireless network controller determines a suitable, for example optimal, set of GWs and ENs. The wireless network controller can instruct the determined optimal set of GWs and ENS to send the D2D synchronization signal. When the OOCC device detects the transmitted D2D synchronization signal, the OOCC device can send a control message (e.g. a synchronization request) to inform the wireless network controller of its approximate location. In some embodiments, this control message is sent to the wireless network controller via one or more GWs and/or ENs which sent the D2D synchronization signal.

After the wireless network controller (e.g. SON controller) instructs the GWs and/or ENs to transmit the D2D synchronization signal, if the wireless network controller does not receive a control message from the OOCC device in a predetermined amount of time, then the wireless network controller may re-evaluate, change or expand the current optimal set of GWs and ENs, thereby generating a new set of GWs and ENs for transmission of the D2D synchronization signal.

In some embodiments, the wireless network controller (e.g. SON controller) optionally executes a local LQE procedure in order to support the process of determining the optimal set of GWs and ENs.

According to embodiments, when it is not clear whether a device is OOCC, the wireless network controller (e.g. SON controller) may determine if the device is an OOCC device, for example using one or more methods. These methods can include the method of the installer informing the wireless network controller when and where the device will be deployed. If the device has not successfully communicated with the wireless network controller even after a predetermined period of time (e.g. timeout), the wireless network controller concludes that the device is an OOCC device. Another method of determining if a device is an OOCC device is if a GW and/or EN receives a synchronization request (e.g. a message or signal indicating that the device is OOCC and wants D2D sync to synchronize) from the OOCC device, the received synchronization request can be forwarded to the wireless network controller.

According to embodiments, when the wireless network controller (e.g. SON controller) is notified of a potential OOCC device, the wireless network controller will determine a suitable, for example optimal, set of GWs and/or ENs to listen for a synchronization request (e.g. a message or signal indicating that the device is OOCC and wants D2D sync to synchronize). The wireless network controller then can instruct the determined optimal set of GWs and ENs to listen for a synchronization request. The instructions of the wireless network controller may indicate a suitable (e.g. optimal) timing and an appropriate (e.g. optimal) period of time for each of the GWs and ENs to listen for the synchronization request.

According to embodiments, the determined optimal set of GWs and ENs will listen for the synchronization request in accordance with the instruction of the wireless network controller, for example alternately or in rotation without overlapping, if possible, within the same geographical area. Such alternate and no-overlapping listening timing can maximize the probability that the set of GWs and ENs decode a potential synchronization request signal or potential synchronization request message.

According to embodiments, after the wireless network controller instructs the GWs and/or ENs to listen for the synchronization request signal or message, if the wireless network controller does not obtain an indication that the synchronization request signal or message was decoded within a predetermined amount of time, then the wireless network controller may re-evaluate, change or expand the current optimal set of GWs and ENs, thereby generating a new set of GWs and ENs to listen for a synchronization request.

According to embodiments, once the OOCC device is identified and connected to the wireless network (e.g. SON), the wireless network controller (e.g. SON controller) can modify power consumption in order to for example optimize the power consumption. In some embodiments, the burden of sending the D2D synchronization signal may be reduced at the GW as one or more synchronized ENs (e.g. ENs within the cellular coverage area) are assigned for the D2D synchronization signal transmission or broadcast.

In some embodiments, the wireless network controller (e.g. SON controller) may further distribute the burden of sending the D2D synchronization signal to multiple synchronized ENs. The wireless network controller may further distribute the transmission of the D2D synchronization signal to further devices when multiple synchronized ENs are positioned near a device that was previously OOCC. The distribution of the burden for sending the D2D SS may be processed using one or more of a plurality of methods, for example a round robin algorithm. It should be noted that, in various embodiments, a previously OOCC device is still able to communicate with the GW and only the synchronization signal needs to be obtained from the ENs.

According to embodiments, the wireless network controller (e.g. SON controller) may assign the closest GW or EN to the OOCC device in order to minimize the power required for transmitting the D2D synchronization signal. The wireless network controller may further adjust the power for the D2D synchronization signal transmission based on the D2D synchronization quality feedback received from the device that was previously OOCC. Therefore, the GW for example may start with high transmission power, and then lower the transmission power in accordance with the wireless network controller's instructions.

The overall process to support an OOCC device described above can be provided in a form of pseudo code, as follows:

Power On or lost connection to GW

[Find GW using cellular Sync]

| ● | Search for all cellular Syncs | |
|---|---|---|
| ● | FOR each cellular BSID found | |
| | ◯ | Sync to BSID |
| | ◯ | Initiate GW discover procedure |
| | ◯ | If successful Authentication, then go to [END] |

| | |
|---|---|
| ● | End FOR |

[Find GW using D2D Sync]

| ● | Search for all D2D Sync | |
|---|---|---|
| ● | FOR each D2D Sync | |
| | ◯ | Initiate GW discovery procedure |
| | ◯ | If successful Authentication, then go to [END] |

| | |
|---|---|
| ● | End FOR |

[Find Cellular systems]

| ● | Search for cellular NW using normal cellular NW discovery procedures | |
|---|---|---|
| ● | IF cellular NW found | |
| | ◯ | Connect to Cellular & ask wireless network controller (e.g. SON |
| | | controller) for instructions |
| | ◯ | Goto [END] |

| | |
|---|---|
| ● | END IF |

[Lost Device Procedure (i.e. No cellular, no D2D Sync)]

| ● | REPEAT | |
|---|---|---|
| | ◯ | Send Sync Requests - Randomly send sync requests to obtain D2D |
| | | sync for DISCOVERY_REQ_T minutes (i.e. for a predetermined amount |
| | | of time) |

| | |
|---|---|
| ▪ | If success, then go to [Find GW using D2D Sync] |

| | |
|---|---|
| ◯ | Search D2D Sync for SEARCH_D2D_T minutes (i.e. Search D2D Sync |
| | for a predetermined amount of time). |

| | |
|---|---|
| ▪ | If SEARCH_D2D_T >= LG_DDRX*(D2D channels to scan), go to |
| | [Find GW using D2D Sync] |

| | |
|---|---|
| ◯ | Search Cellular - if success then go to [Find Cellular systems] |
| ◯ | Sleep for SLEEP_T minutes |
| ◯ | Adjust or exponentially increase SLEEP_T (can be increased until it |
| | reaches a maximum MAX_SLEEP_T) |

| | |
|---|---|
| ● | Go to REPEAT |

[END]

### Frequent Network Re-configuration

When an EN is moving frequently (e.g. in the case of a device used for container tracking), network re-configuration occurs frequently, in particularly when compared to the case of a static EN. Such frequent network re-configuration can have a direct impact on the battery life of the ENs. Therefore, it is desired to have a solution ensuring that a frequently moving EN is maintained in the coverage area while preventing high battery usage during the network re-configuration.

According to embodiments, while being within the cellular coverage area, the EN can contact the wireless network controller (e.g. SON controller) via the cellular network when communications with the GW are lost. Such communication with the wireless network controller can allow for quick re-organization (re-configuration) of the network (e.g. SON) and re-assignment of the EN to a new GW.

While more challenging, embodiments of the present disclosure can also handle the cases where ENs lose their connection with a GW and are not within the cellular coverage area. According to embodiments, the wireless network controller (e.g. SON controller) receives information relating to when ENs are highly mobile so that it can instruct ENs and GWs within the wireless network (e.g. SON) or ENs within the local area to send the D2D synchronization signal regularly. In some embodiments, the wireless network controller may instruct the sending of a D2D synchronization signal more frequently.

In some embodiments, the wireless network controller (e.g. SON controller) may determine the level of the D2D synchronization (e.g. set the frequency of D2D synchronization signal transmission, set the frequency of synchronization request reception). The wireless network controller may set the level of the D2D synchronization based on the mobility level indicated by the EN and the reliability level received from the customer, for example which can be defined as a desired reliability level. The D2D synchronization signal may be transmitted from the wireless network controller.

In some embodiments, the wireless network controller (e.g. SON controller) may adjust the level of the D2D synchronization (e.g. set the frequency of D2D synchronization signal transmission, set the frequency of synchronization request reception) based on the frequency that the ENs lose connections to the GW. The frequency of the connection lost may indicate the mobility and the reliability of the ENs.

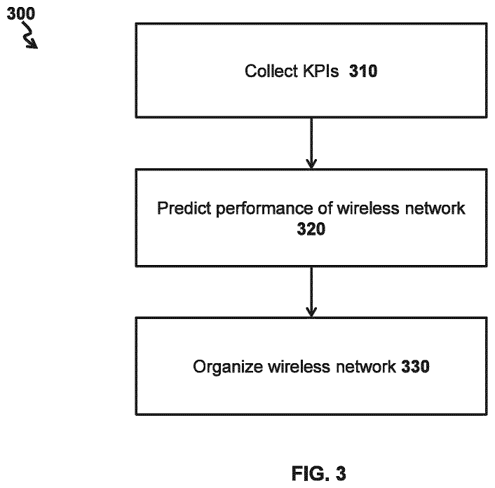

FIG. 3 is a method for managing device-to-device communications in a wireless network (e.g. self-organizing network (SON)), in accordance with embodiments of the present disclosure. The method includes collecting 310, by a wireless network controller (e.g. SON controller), one or more key performance indicators (KPI). Each of the KPIs indicative of an attribute of the wireless network (e.g. attribute of the SON). The method further includes predicting 320, by the wireless network controller, performance of the wireless network based on the collected one or more KPIs. Upon determination that the predicted performance meets a target performance, the method further includes organizing 330, by the wireless network controller, the wireless network (e.g. SON) based on the predicted performance of the wireless network, the organization including assigning one or more network devices as a gateway (GW) or an end node (EN).

In some embodiments, the one or more KPIs include one or more of: a target monthly operating cost, a mobile device originated (DO) latency, a mobile device terminated (DT) latency, a data volume, a data rate, a reliability, and a power consumption of at least one of the GWs and the ENs. In some embodiments, the one or more of the KPIs have assigned values. In some embodiments, the wireless network controller (e.g. SON controller) estimates values of the remaining KPIs.

In some embodiments, the wireless network controller (e.g. SON controller) organizes the wireless network (e.g. SON) based further on one or more relational factors, the relational factors including relationships between two of: an operation cost, a number of end nodes (EN) per gateway (GW), an EN originated latency, an EN terminated latency, a length of GW discontinuous reception (DRX) cycle, a length of EN DRX cycle, a maximum number of mesh hops, a bandwidth data rate, a reliability, a number of GWs within a coverage area of the ENs, a power consumption of the GW, a coverage level, and an aggregation level.

In some embodiments, wherein the wireless network controller (e.g. SON controller) further reorganizes the wireless network (e.g. SON) after deployment, based on one or more operational factors, the operational factors including a radio frequency (RF) topology information, a data load on each EN and GW, remaining battery capacity and a network geographical topology.

In some embodiments, organizing the wireless network (e.g. SON) further includes performing, by the wireless network controller, a link quality evaluation (LQE) process to update RF link quality information. In some embodiments, the LQE process includes transmitting, by the wireless network controller, a LQE configuration message to one or more network devices and transmitting, by one of the network devices, an LQE synchronization signal (LQE_SS). The LQE process further includes measuring and recording, by remaining devices of the network devices, quality of the LQE_SS and transmitting, by each network device, an LQE report to the wireless network controller, the LQE report based on the measurement of the quality of the LQE_SS.

In some embodiments, the one or more network devices are deployed out of cellular coverage (OOCC) area, and synchronizing includes broadcasting, by one or more ENs and GWs, a device-to-device (D2D) synchronization signal according to an instruction of the wireless network controller (e.g. SON controller). In some embodiments, the wireless network controller (e.g. SON controller) selects the one or more ENs and GWs to broadcast the D2D synchronization signal.

In some embodiments, the wireless network controller (e.g. SON controller) provides one or more ENs and GWs instructions in respect to how frequently transmit the D2D synchronization signal. In some embodiments, the wireless network (e.g. SON) determines level of the D2D synchronization based on mobility level indicated by the ENs and a desired reliability level.

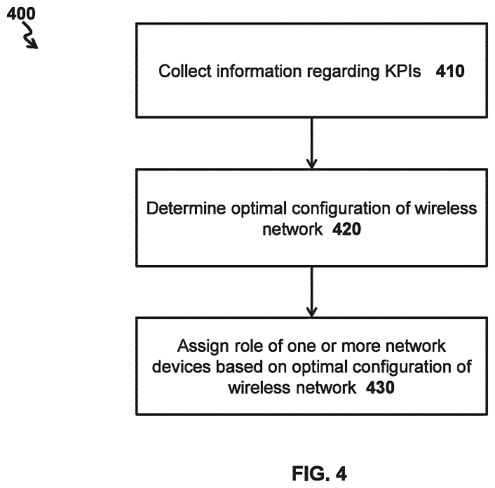

FIG. 4 is a method for managing device-to-device communications in a wireless network (e.g. self-organizing network (SON)), in accordance with embodiments of the present disclosure. The method includes collecting, 410, by a wireless network controller, information regarding one or more key performance indicators (KPIs). The information relates to one or more of a ranking of the one or more KPIs and a target value of the one or more KPIs. The method further includes determining, 420, by the wireless network controller, an optimal configuration of the wireless network that best meets the collected information relating to the one or more KPIs. The method additionally includes assigning, 430, by the wireless network controller, a role to each of one or more network devices associated with the wireless network based on the optimal configuration of the wireless network. In some embodiments, the method includes assigning, 430, by the wireless network controller, a role to one or more of the one or more network devices associated with the wireless network based on the optimal configuration of the wireless network. The role is selected from a gateway (GW), a mesh node, a cellular node and an end node (EN).

In some embodiments, the wireless network controller assigns a role to each of a plurality of network devices. In some embodiments, the one or more KPIs includes one or more of: a monthly operating cost, a device originated (DO) latency, a device terminated (DT) latency, a data volume, a data rate, a reliability, a network geographical topology, a number of devices per gateway (GW), a length of a device discontinuous reception (DRX) cycle, a maximum number of mesh hops, a number of GWs within a coverage area of the one or more the network devices, a coverage level, an aggregation level, a radio frequency (RF) link quality information, remaining battery capacity and a power consumption, wherein the KPIs apply to at least one of the network devices.

In some embodiments, the wireless network controller estimates a value of one or more KPIs that are uncollected. In some embodiments, the one or more KPIs are related to each other.

In some embodiments, the method further includes initiating, by the wireless network controller, a link quality evaluation (LQE) process to update RF link quality information. In some embodiments, the LQE process includes transmitting, by the wireless network controller, a configuration message to one or more network devices. The configuration message indicating a timing of transmission of a signal for evaluating the RF link quality. The LQE process further includes transmitting, by one of the one or more network devices, the signal and measuring and recording, by remaining one or more network devices, a quality of the signal. The LQE process further includes transmitting, by each network device, an LQE report to the wireless network controller, the LQE report based on the measurement of the quality of the signal.

In some embodiments, assigning further includes instructing at least one of the one or more network devices to broadcast a device-to-device synchronization signal. In some embodiments, the wireless network controller provides the at least one of the one or more network devices instructions relating to how frequently to transmit the D2D synchronization signal. In some embodiments, the wireless network controller determines a level of the D2D synchronization based on a mobility level indicated by the one or more network devices and a desired reliability level.

In some embodiments, determining the optimal configuration further includes determining, by the wireless network controller, one or more predicted KPIs for multiple configurations of the wireless network. In some embodiments, the multiple configurations of the wireless network are based on the collected information.

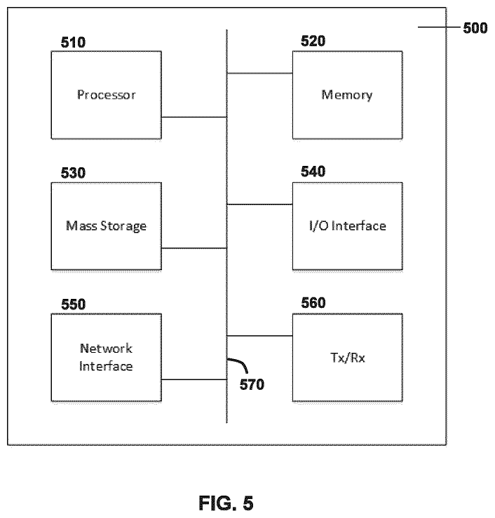

FIG. 5 is a schematic diagram of an electronic device 500 that may perform any or all of the steps of the above methods and features described herein, according to different embodiments. For example, network devices, network nodes, end nodes, computer devices, wireless gateways, mobility routers, access point devices, controller devices, wireless network controllers, SON controllers can be configured as the electronic device. End-user computers, smartphones, IoT devices, etc. can be also configured as electronic devices.

As shown, the device includes a processor 510, memory 520, non-transitory mass storage 530, I/O interface 540, network interface 550, and a transceiver 560, all of which are communicatively coupled via bi-directional bus 570. According to certain embodiments, any or all of the depicted elements may be utilized, or only a subset of the elements. Further, the device 500 may contain multiple instances of certain elements, such as multiple processors, memories, or transceivers. Also, elements of the hardware device may be directly coupled to other elements without the bi-directional bus.

The memory 520 may include any type of non-transitory memory such as static random access memory (SRAM), dynamic random access memory (DRAM), synchronous DRAM (SDRAM), read-only memory (ROM), any combination of such, or the like. The mass storage element 530 may include any type of non-transitory storage device, such as a solid state drive, hard disk drive, a magnetic disk drive, an optical disk drive, USB drive, or any computer program product configured to store data and machine executable program code. According to certain embodiments, the memory 520 or mass storage 530 may have recorded thereon statements and instructions executable by the processor 510 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for managing communications in a wireless network, the method comprising:
collecting, by a wireless network controller, information regarding one or more key performance indicators (KPIs), wherein the information relates to one or more of a ranking of the one or more KPIs and a target value of the one or more KPIs;
determining, by the wireless network controller, an optimal configuration of the wireless network that best meets the collected information relating to the one or more KPIs;
assigning, by the wireless network controller, a role to each of one or more network devices associated with the wireless network based on the optimal configuration of the wireless network, wherein the role is selected from a gateway (GW), a mesh node, a cellular node and an end node (EN).

2. The method of claim 1, wherein the wireless network controller assigns a role to each of a plurality of network devices.

3. The method of claim 1, wherein the one or more KPIs includes one or more of: a monthly operating cost, a device originated (DO) latency, a device terminated (DT) latency, a data volume, a data rate, a reliability, a network geographical topology, a number of devices per gateway (GW), a length of a device discontinuous reception (DRX) cycle, a maximum number of mesh hops, a number of GWs within a coverage area of the one or more the network devices, a coverage level, an aggregation level, a radio frequency (RF) link quality information, remaining battery capacity and a power consumption, wherein the KPIs apply to at least one of the network devices.

4. The method of claim 1, wherein the wireless network controller estimates a value of one or more KPIs that are uncollected.

5. The method of claim 3, wherein the one or more KPIs are related to each other.

6. The method of claim 1, further comprising initiating, by the wireless network controller, a link quality evaluation (LQE) process to update RF link quality information.

7. The method of claim 6, wherein the LQE process includes:
transmitting, by the wireless network controller, a configuration message to one or more network devices, wherein the configuration message indicates a timing of transmission of a signal for evaluating the RF link quality;
transmitting, by one of the one or more network devices, the signal;
measuring and recording, by remaining one or more network devices, a quality of the signal; and
transmitting, by each network device, an LQE report to the wireless network controller, the LQE report based on the measurement of the quality of the signal.

8. The method of claim 1, wherein assigning further includes:
instructing at least one of the one or more network devices to broadcast a device-to-device (D2D) synchronization signal.

9. The method of claim 8, wherein the wireless network controller provides the at least one of the one or more network devices instructions relating to how frequently to transmit the D2D synchronization signal.

10. The method of claim 9, wherein the wireless network controller determines a level of the D2D synchronization based on a mobility level indicated by the one or more network devices and a desired reliability level.

11. The method of claim 1, wherein determining the optimal configuration further includes determining, by the wireless network controller, one or more predicted KPIs for multiple configurations of the wireless network.

12. The method of claim 11, wherein the multiple configurations of the wireless network are based on the collected information.

13. A wireless network controller within a wireless network, the wireless network controller comprising:
a network interface for receiving data from and transmitting data to network devices connected to the wireless network;
a processor; and
machine readable memory storing machine executable instructions which when executed by the processor configure the wireless network controller to:
collect information regarding one or more key performance indicators (KPIs), wherein the information relates to one or more of a ranking of the one or more KPIs and a target value of the one or more KPIs;
determine an optimal configuration of the wireless network that best meets the collected information relating to the one or more KPIs; and
assign a role to each of one or more network devices associated with the wireless network based on the optimal configuration of the wireless network, wherein the role is selected from a gateway (GW), an end node (EN), a mesh node and a cellular node and an end node (EN).

14. The wireless network controller of claim 13, wherein the wireless network controller assigns a role to each of a plurality of network devices.

15. The wireless network controller of claim 13, wherein the one or more KPIs includes one or more of: a monthly operating cost, a device originated (DO) latency, a device terminated (DT) latency, a data volume, a data rate, a reliability, a network geographical topology, a number of devices per gateway (GW), a length of device discontinuous reception (DRX) cycle, a maximum number of mesh hops, a number of GWs within a coverage area of the one or more network devices, a coverage level, an aggregation level, a radio frequency (RF) link quality information, remaining battery capacity and a power consumption, wherein the KPIs apply to at least one of the network devices.

16. The wireless network controller of claim 14, wherein the machine executable instructions which when executed by the processor further configure the wireless network controller to estimate a value of one or more KPIs that are uncollected.

17. The wireless network controller of claim 13, wherein the one or more KPIs are related to each other.

18. The wireless network controller of claim 13, wherein machine executable instructions which when executed by the processor further configure the wireless network controller to initiate a link quality evaluation (LQE) process to update RF link quality information.

19. The wireless network controller of claim 18, wherein the LQE process includes:
transmitting, by the wireless network controller, a configuration message to one or more network devices, wherein the configuration message indicates a timing of transmission of a signal for evaluating the RF link quality;
transmitting, by one of the one or more network devices, the signal;
measuring and recording, by remaining one or more network devices, a quality of the signal; and
transmitting, by each network device, an LQE report to the wireless network controller, the LQE report based on the measurement of the quality of the signal.

20. The wireless network controller of claim 13, wherein the machine executable instructions which when executed by the processor further configure the wireless network controller to instruct at least one of the one or more network devices to broadcast a device-to-device (D2D) synchronization signal.

21. The wireless network controller of claim 20, wherein the machine executable instructions which when executed by the processor further configure the wireless network controller to provide the one or more network devices instructions relating to how frequently to transmit the D2D synchronization signal.

22. The wireless network controller of claim 20, wherein the machine executable instructions which when executed by the processor further configure the wireless network controller to determine a level of the D2D synchronization based on a mobility level indicated by the one or more network devices and a desired reliability level.
